(19) United States
(12) Patent Application Publication
(10) Pub. No.: US 2007/0148520 A1
(43) Pub. Date: Jun. 28, 2007

(54) Novel metal (III) -chromium-phosphate complex and use thereof

(76) Inventors: Chong Kyu Shin, Yuseong-gu (KR); Jung Hye Won, Seoul (KR); Bong Keun Lee, Yuseong-gu (KR); Yong Su Park, Bucheon-si (KR); Jae Hyuk Chang, Yuseong-gu (KR); Dong Pyo Kim, Yuseong-gu (KR)

Correspondence Address: MCKENNA LONG & ALDRIDGE LLP, 1900 K STREET, NW, WASHINGTON, DC, 20006, US

(21) Appl. No.: 11/644,964

(22) Filed: Dec. 26, 2006

(30) Foreign Application Priority Data
Dec. 27, 2005 (KR) 2005-130429

(51) Int. Cl. H01M 8/10; C01B 25/45; H01M 4/86

(52) U.S. Cl. 429/33; 423/307; 423/306; 429/40; 429/42

(57) ABSTRACT

Disclosed herein are a metal(III)-chromium-phosphate complex represented by a formula of M(III)ₓCr(HPO₄)_{y}(H₂PO₄)_{z} and the use thereof. More particularly, disclosed are an organic/inorganic composite electrolyte membrane comprising said complex, an electrode comprising said complex, a membrane-electrode assembly (MEA) comprising said organic/inorganic composite electrolyte membrane and/or electrode, and a fuel cell comprising said membrane-electrode assembly.

This application claims the benefit of the filing date of Korean Patent Application No. 10-2005-0130429, filed on Dec. 27, 2005, in the Korean Intellectual Property Office, the disclosure of which is incorporated herein in its entirety by reference.

### BACKGROUND OF THE INVENTION

(a) Field of the Invention

The present invention relates to a metal(III)-chromium-phosphate (hereinafter sometimes referred to as “MCP”) complex represented by a formula of M(III)ₓCr(HPO₄)_{y}(H₂PO₄)_{z} and the use thereof, and more particularly to an organic/inorganic composite electrolyte membrane comprising said complex, an electrode for fuel cells, comprising said complex, a membrane-electrode assembly (MEA) for fuel cells, comprising said organic/inorganic composite membrane and/or said electrode, and a fuel cell comprising said membrane-electrode assembly.

(b) Description of the Related Art

Fuel cells are energy conversion devices that convert the chemical energy of fuel directly into electrical energy, and have been studied and developed as the next-generation energy sources, due to high energy efficiency and eco-friendly properties such as low pollutant emission.

A polymer electrolyte membrane fuel cell (PEMFC) that uses hydrogen as fuel can operate in a wide temperature range, and thus has advantages in that a cooling device is not required and sealing parts can be simplified. Also, it uses non-humidified hydrogen as fuel and thus does not require the use of a humidifier. In addition, it can be rapidly driven. Due to such advantages, it receives attention as a power source device for cars and homes. Furthermore, it is a high-output fuel cell having a current density higher than those of other types of fuel cells such as direct methanol fuel cells, can operate in a wide temperature range and has a simple structure and rapid starting and response characteristics.

As a polymer electrolyte membrane for such high-temperature fuel cells, Celazole™, which is polyazole-based polybenzimidazole, is typically known. The fuel cell that uses the polybenzimidazole polymer electrolyte membrane is usually driven using non-humidified hydrogen as fuel at temperatures of more than 100° C., particularly 120° C. Thus, as described above, it has advantages in that a cooling device is not required, sealing parts are simplified, the use of a humidifier is eliminated and the activity of a noble metal-based catalyst present in the membrane-electrode assembly (MEA) is increased.

Generally, when hydrocarbon compounds such as natural gas are used as fuel after modification, a considerable amount of carbon monoxide is included in the modified gas. Thus, when carbon monoxide is not removed from the modified gas through a post-treatment or purification process, it will poison catalysts, leading to a significant reduction in the performance of fuel cells. However, a fuel cell that uses a polyazole-based polymer electrolyte membrane can be driven at high temperatures, so that catalyst poisoning caused by carbon monoxide is minimized. Thus, in this fuel cell, high concentrations of carbon monoxide impurities are permitted.

Despite many known advantages, polybenzimidazole (PBI), a polyazole polymer, shows a hydrogen ion conductivity lower than that (10⁻¹ S/cm) of currently commercialized Nafion™. To increase the hydrogen ion conductivity of polybenzimidazole, studies to prepare a composite electrolyte membrane by adding an inorganic metallic material having high hydrogen ion conductivity to polybenzimidazole are being actively conducted. Several examples thereof are as follows.

P. Staiti et al. (Journal of Power Sources 2001, Vol 94, 9) discloses a method of preparing a composite electrolyte membrane after adding heteropolyacid PWA (phosphotungstic acid)/SiO₂ and SiWA (silicotungstic acid)/SiO₂ to a solution of polybenzimidazole in dimethylacetamide. However, the composite electrolyte membrane prepared using this method showed a low hydrogen ion conductivity of about 10⁻³ S/cm at a temperature higher than 100° C. in a 100% relative humidity condition. Such a value does not satisfy the non-humidified condition and the hydrogen ion conductivity required in the operation of fuel cells.

Also, WO 2004/074179 A1 and N. J. Bjerrum et al. (Journal of Membrane Science 2003, Vol 226, 169-184) disclose a method of preparing a composite electrolyte membrane after adding ZrP (zirconium phosphate) to a solution of polybenzimidazole in dimethylacetamide. The composite electrolyte membrane prepared using this method showed a hydrogen ion conductivity of 5×10⁻² S/cm in a relative humidity condition of 20% at a temperature of 140° C., and a high hydrogen ion conductivity of 10⁻¹ S/cm in a relative humidity condition of 5% and a temperature of 200° C. However, these values do not agree with properties required for fuel cells that should satisfy high hydrogen conductivity in a wide temperature and non-humidified conditions. Also, the composite electrolyte membrane, comprising PWA and SiWA added to polybenzimidazole, showed a hydrogen ion conductivity value rather lower than that of the polybenzimidazole electrolyte membrane itself at a temperature of more than 120° C. in a relative humidity condition of 5%.

Moreover, Y. Yamazaki et al. (Journal of Power Sources 2005, Vol. 139, 2-8) discloses a method of preparing a composite electrolyte membrane after adding zirconium tricarboxybutylphosphonate to a solution of polybenzimidazole in dimethylacetamide. The composite electrolyte membrane prepared using this method showed a stable hydrogen ion conductivity value of 10⁻² S/cm in a relative humidity condition of 100% and a relatively wide temperature range of 80-200° C., but does not satisfy non-humidified conditions required in the operation of fuel cells.

In addition, J. A. Asensio et al. (Electrochimica Acta 2005, Vol 50, 4715-4720) disclose a method of preparing a composite electrolyte membrane after adding phosphomolybdic acid (heteropoly acid) to a solution of polybenzimidazole in methanesulfonic acid. This electrolyte membrane shows a stable hydrogen ion conductivity value of 10⁻² S/cm in non-humidified conditions and a relatively wide temperature range of 120-200° C., but this ion conductivity value does not reach the hydrogen ion conductivity (10⁻¹ S/cm) of currently commercialized Nafion-based electrolyte membranes.

Furthermore, the organic/inorganic composite electrolyte membranes disclosed in said documents require a separate post-treatment process for doping with acids (phosphoric acid, sulfuric acid, etc.) in order to impart high hydrogen ion conductivity, and the resulting electrolyte membranes show the non-optimized morphology between the polyazole polymer, the strong acid and the inorganic metallic material. Thus, the doped strong acid is easily separated from the electrolyte membranes at high temperatures, causing a rapid decrease in the ion conductivity of the membranes with the passage of operating time.

### SUMMARY OF THE INVENTION

Accordingly, an object of the present invention is to solve the above-described problems occurring in the prior art and technical problems that have been requested in the prior art.

Specifically, a first object of the present invention is to provide a novel metal(III)-chromium-phosphate (MCP) complex having various advantages in that, for example, it shows high hydrogen ion conductivity in a wide temperature range and non-humidified conditions.

A second object of the present invention is to provide an organic/inorganic composite electrolyte membrane, which is prepared by adding said MCP complex to an organic polymer as a matrix component, so that it shows high hydrogen ion conductivity in a wide temperature range covering high temperatures and in non-humidified conditions, does not require a post-treatment process and shows a low decrease in the ion conductivity thereof with the passage of operating time.

A third object of the present invention is to provide an electrode for fuel cells, which is prepared by applying said MCP complex together with a noble metal-based catalyst, a binder and the like on a gas diffusion layer, so that it shows high hydrogen ion conductivity in a wide temperature range covering high temperatures and in non-humidified conditions and, at the same time, shows increased catalyst activity.

A fourth object of the present invention is to provide a membrane-electrode assembly (MEA) comprising at least said organic/inorganic composite membrane or electrode.

A fifth object of the present invention is to provide a fuel cell having improved performance, which comprises said membrane-electrode assembly.

To achieve the above objects, the present invention provides a metal(III)-chromium-phosphate (MCP) complex represented by Formula (1) below:
M(III)ₓCr(HPO₄)_{y}(H₂PO₄)_{z} (1)
wherein M is a group IIIA and/or group IIIB metal, x is 3n (n=1 or 2), y is 3n′ (n′=0, 1 or 2), z is 3n″ (n″=0, 1 or 2), at least one of n′ and n″ is not zero.

According to another aspect, the present invention provides an organic/inorganic composite electrolyte membrane comprising: an organic polymer; and said metal(III)-chromium-phosphate (MCP) complex represented by Formula (1), dispersed on a matrix of said organic polymer.

According to still another aspect, the present invention provides an electrode for fuel cells, comprising said metal(III)-chromium-phosphate (MCP) complex represented by Formula (1).

According to yet another aspect, the present invention provides a membrane-electrode assembly (MEA) for fuel cells, comprising a cathode, an anode and an electrolyte membrane placed between the cathode and the anode, in which (i) the electrolyte membrane is said organic/inorganic composite electrolyte membrane according to the present invention, and/or (ii) the cathode and/or the anode is said electrode according to the present invention.

According to yet still another aspect, the present invention provides a fuel cell comprising said membrane-electrode assembly.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a graphic diagram showing the hydrogen ion conductivity with a change in temperature of a composite electrolyte membrane prepared in each of Example 4 and Comparative Example 1.

### DETAILED DESCRIPTION OF THE INVENTION

Reference will now be made in detail to the preferred embodiments of the present invention.

A metal(III)-chromium-phosphate complex according to the present invention is a material represented by Formula (1) below:
M(III)ₓCr(HPO₄)_{y}(H₂PO₄)_{z} (1)
wherein M is a group IIIA and/or group IIIB metal, x is 3n (n=1 or 2), y is 3n′ (n′=0, 1 or 2), z is 3n″ (n″=0, 1 or 2), at least one of n′ and n″ is not zero.

The MCP complex is novel in itself, and as described in detail below, it has many advantages in that, for example, it shows high hydrogen ion conductivity in a wide temperature range and non-humidified conditions and forms a stable morphology when it reacts with organic polymers. Thus, it can preferably be used in electrochemical devices such as fuel cells.

M in Formula (1) above can be selected from among, for example, group IIIA metals, including B, Al, Ga, In and Ti, and group IIIB metals, including Sc, Y and Lu, and in some cases, can be used in a combination of two or more of the metal elements. Among them, Al is particularly preferred.

The MCP complex according to the present invention can be prepared using various methods. For example, it can be prepared by allowing (i) metal hydroxide (M(OH)₃) and/or metal oxide (M₂O₃) and (ii) chromium oxide (CrO₃) to react with (iii) polyphosphoric acid (Hₙ₊₂PₙO₃ₙ₊₁; n=an integer not smaller than 1). Preferably, it can be prepared by adding metal hydroxide and chromium hydroxide into a phosphoric acid (H₃PO₄) solution in an inert atmosphere and allowing the mixture solution to react at a temperature of 40˜100° C., and preferably 50˜80° C. If it is preferable that the MCP complex be present in a liquid phase for use as the raw material of an electrolyte membrane or electrode to be described later, it can also be prepared as a MCP complex solution by using an excess amount of a phosphoric acid solution during the reaction for the preparation thereof or adding an additional phosphoric acid solution after the reaction.

The organic/inorganic composite electrolyte membrane according to the present invention comprises: an organic polymer; and said metal(III)-chromium-phosphate (MCP) complex represented by Formula (1), dispersed on a matrix of the organic polymer.

The organic/inorganic composite electrolyte membrane according to the present invention shows excellent chemical resistance and thermal stability and has stable hydrogen ion-conducting channels between the organic polymer and the MCP complex. Thus, it shows high hydrogen ion conductivity even in a wide temperature range including, for example, 200° C. and non-humidified conditions. Such hydrogen ion conductivity is about 0.01˜0.8 S/cm, which is higher than those of the prior electrolyte membranes in non-humidified conditions and a wide temperature range and reaches the hydrogen ion conductivity level of Nafion.

Examples of the organic polymer, which can be used in the present invention, include PTFE (polytetrafluoroethylene), PVDF (polyvinylidenefluoride), Nafion-based polymers, PA (polyamide)-based polymers, PI (polyimide)-based polymers, PVA (polyvinylalcohol)-based polymers, PAE (polyaryleneether)-based polymers, and polyazole-based polymers, which can be used alone or in a mixture of two or more thereof. Particularly, in order to form more stable hydrogen ion-conducting channels between the organic polymer and the MCP complex, it is preferable to use an organic polymer having at least one hydrogen ion exchange group selected from the group consisting of a sulfonic acid group, phosphoric acid group, hydroxyl group and carboxylic acid group.

The content range of the MCP complex in the composite electrolyte membrane is not specifically limited as long as it is a range that can show high hydrogen ion conductivity as described above while growing films. The MCP complex can be used in an amount of, for example, 0.1˜1000 parts by weight and preferably 50˜500 parts by weight, based on 100 parts by weight of the organic polymer.

The organic/inorganic composite electrolyte membrane may comprise, in addition to the above-described components, other conventional components and additives known in the art. Also, the thickness of the organic/inorganic composite electrolyte membrane is not specifically limited and can be controlled in a range that improves the performance and safety of fuel cells.

The organic/inorganic composite electrolyte membrane according to the present invention can be prepared according to a conventional method known in the art. For example, it can be prepared through a method comprising the steps of: (i) mixing said organic polymer or a solution thereof with said MCP complex or a solution thereof to prepare a mixture; and (ii) forming said mixture into a membrane, and then crosslinking and/or curing the membrane.

In the step (i), a solvent of dissolving the organic polymer preferably has a solubility index similar to that of a polymer to be used and a low boiling point, in order to ensure uniform mixing and make subsequent solvent removal easy. However, the scope of the present invention is not limited thereto, and any conventional solvent in the art can be used. Non-limiting examples of the solvent of dissolving the organic polymer include N,N′-dimethylacetamide (DMAc), N-methylpyrrolidone (NMP), dimethyl sulfoxide (DMSO), N,N-dimethylformamide (DMF), phosphoric acid, polyphosphoric acid and the like.

The step (ii) of forming the mixture into the membrane and then crosslinking and/or the membrane can be carried out, for example, by coating and curing said complex on a substrate such as a glass plate and then separating an electrolyte membrane from the substrate.

A method of coating the mixture on the substrate may be a conventional method known in the art. For example, it can be dip coating, die coating, roll coating, comma coating, doctor blade coating or a combination thereof.

More specifically, in one preferred of the preparation of the electrolyte membrane according to the present invention, the electrolyte membrane can be prepared by preparing a solution of the organic polymer using an excess amount of polyphosphoric acid and phosphoric acid, adding the MCP complex to the organic polymer solution, stirring the mixture at 100˜200° C. for a given time, adding an additional amount of polyphosphoric acid and phosphoric acid to the stirred mixture to make a suitable viscosity, forming the mixture solution into a membrane, and inducing hydrolysis of the polyphosphoric acid at a relative humidity of 30˜50% to remove an excess of phosphoric acid.

This electrolyte membrane is maintained at 100˜250° C. for 1˜20 hours in order to induce the crosslinking and/or curing thereof, so that a stable morphology of the MCP complex in the organic polymer can be obtained.

The electrode for fuel cells according to the present invention comprises said organic polymer; and said metal(III)-chromium-phosphate (MCP) complex represented by Formula (1). The electrode for fuel cells according to the present invention is an electrode that induces an electrochemical reaction by the action of a catalyst, and examples thereof include a cathode and an anode.

This electrode can be prepared, for example, by applying said MCP complex solution, a noble metal-based catalyst, a binder and a solvent on a gas diffusion layer (GDL) made of, for example, carbon paper or carbon cloth, followed by crosslinking and/or curing. Examples of the noble metal-based catalyst include Pt, W, Ru, Mo and Pd, which can be in a form supported on carbon.

The binder is a component that fixes and links the catalyst and the MCP complex to the gas diffusion layer, and a conventional hydrogen ion-conducting polymer known in the art can be used as the binder. Specifically, this binder can be a polymer which can be contained as the component of the electrolyte membrane. Non-limiting examples thereof include polytetrafluoroethylene (PTFE), fluoroethylene copolymers, Nafion and the like, but the scope of the present invention is not limited thereto.

Particularly, in order to form stable hydrogen ion-conducting channels between the electrode catalyst and the MCP complex, the binder is preferably an organic polymer having at least one hydrogen ion exchange group selected from the group consisting of a sulfonic acid group, phosphoric acid group, hydroxyl group and carboxylic acid group.

Non-limiting examples of the solvent for use in the preparation of the electrode include water, butanol, isopropyl alcohol (IPA), methanol, ethanol, n-propanol, n-butyl acetate, and ethylene glycol, and these solvents can be used alone or in a mixture of two or more thereof.

Due to stable hydrogen ion-conducting channels formed between the binder (organic polymer) and the MCP complex, the electrode for fuel cells according to the present invention shows high hydrogen ion conductivity in a wide temperature range and non-humidified conditions, and has increased catalyst activity due to chromium contained in the MCP complex.

The content of the MCP complex is not specifically limited as long as it is a content that forms an electrode by application to the gas diffusion layer and can show excellent properties as described above. The MCP complex can be added in an amount of, for example, 0.1˜1000 parts by weight and preferably 50˜400 parts by weight, based on 100 parts by weight of the binder.

Also, the membrane-electrode assembly according to the present invention comprises a cathode, an anode and an electrolyte membrane placed between the cathode and the anode, in which (i) the electrolyte membrane is said organic/inorganic composite electrolyte membrane according to the present invention, and/or (ii) the cathode and/or the anode is said electrode according to the present invention.

The membrane-electrode assembly for fuel cells consists of a structure in which the electrolyte membrane showing cation conductivity is assembled with the electrodes comprising the catalyst for electrochemical reactions. The membrane-electrode assembly is a key structure in fuel cells.

According to the present invention, at least one of the electrolyte membranes and the electrode contains said MCP complex, thus providing a membrane-electrode assembly that has excellent operating characteristics in a wide temperature range and non-humidified conditions.

In one preferred embodiment of the present invention, the membrane-electrode assembly can be prepared by bringing a cathode, an anode and an electrolyte membrane placed therebetween, which contain the MCP complex, into close contact with each other, and then crosslinking and/or curing the resulting structure at 100˜400° C.

Specifically, a method for fabricating this membrane-electrode assembly may comprise the steps of:

(a) preparing a solution of the MCP complex;

(b) preparing an organic/inorganic composite electrolyte membrane using the MCP complex solution and an organic polymer solution as a matrix component;

(c) preparing an electrode applying a mixture of the MCP complex solution, a noble metal-based catalyst, a binder and a solvent on carbon paper or carbon cloth; and

(d) bringing the electrolyte membrane and the electrode into close contact with each other and crosslinking and/or curing the resulting structure at 100˜400° C.

In the step (d), a particularly preferred crosslinking and/or curing temperature range is 150˜250° C.

The fuel cell according to the present invention comprises said membrane-electrode assembly.

The fuel cell according to the present invention shows high hydrogen ion conductivity even at high temperature in non-humidified conditions, and thus can be preferably used, in particular, as a fuel cell that uses non-humidified hydrogen as fuel.

Other constructions and fabrication methods of the fuel cell are known in the art, and the description thereof will be omitted herein. Also, other specific contents for the construction of the membrane-electrode assembly in the present invention are known in the art, and thus the membrane-electrode assembly will be sufficiently reproducible even though a separate description is not given herein.

Hereinafter, preferred examples will be described for a better understanding of the present invention. It is to be understood, however, that these examples are illustrative only and the scope of the present invention is not limited thereto.

### EXAMPLES

### Example 1

### Preparation of Polyparabenzimidazole Copolymer

Terephthalic acid and 3,3′,4,4′-tetraminobiphenyl for use in polymerization were previously dried in a vacuum at 80° C. for at least 24 hours. Also, as a solvent, polyphosphoric acid (P₂O₅: 85%, H₃PO₄: 115%) provided from JUNSEI was used.

80 g of polyphosphoric acid was added into a reactor equipped with a stirrer in a nitrogen atmosphere, and the temperature of the reactor was elevated to 170° C. to make the stirring of the polyphosphoric acid easy. Then, 3.000 g (9.334 mmol) of 3,3′,4,4′-tetraminobiphenyl and 2.326 g (9.334 mmol) of terephthalic acid were added to the polyphosphoric acid, and the mixture was stirred for 48 hours. Then, 80 g of polyphosphoric acid and phosphoric acid were additionally added to the solution and stirred to reduce the viscosity of the solution. As a result, a polyphosphoric acid solution of poly(2,2-p-(phenylene)-5,5-bibenzimidazole) was prepared.

### Example 2

### Preparation of Aluminum-Chromium-Phosphate Complex

Al(OH)₃ and CrO₃ were used in a 85% phosphoric acid solution to prepare an aluminum-chromium-phosphate complex of Al(OH)₃:CrO₃:H₃PO₄=3:1:9 (mole ratio). For this purpose, Al(OH)₃ was added to a 85% phosphoric acid solution and dissolved at 80° C. for 20 minutes until a clear solution was formed. Then, CrO₃ was added thereto and the mixture was stirred for 1 hour while methanol was slowly added thereto, thus preparing an aluminum-chromium-phosphate complex [Al₃Cr(HPO₄)₃ (H₂PO₄)₆]

### Example 3

### Preparation of Composite of Polyparabenzimidazole/Aluminum-Chromium-Phosphate

10 g of the aluminum-chromium-phosphate prepared in Example 2 was added to 100 g of the polyphosphoric acid solution of 15 wt % of polyparabenzimidazole prepared in Example 1. The mixture was stirred at 150° C. for 6 hours, thus preparing a solution of about 50 wt % of a polyparabenzimidazole/aluminum-chromium-phosphate composite.

### Example 4

### Preparation of Organic/Inorganic Composite Electrolyte Membrane of Polybenzimidazole/Aluminum-Chromium-Phosphate (Sample 1)

30 g of polyphosphoric acid and phosphoric acid were additionally added to the polybenzimidazole/aluminum-chromium-phosphate composite solution prepared in Example 3, and the solution was then prepared into a film according to a method of directly pouring a solution. For this purpose, a doctor blade and a glass plate for use as a support were heated to about 200° C. before use. The composite solution was poured onto the heated support, and then the composite solution was applied to a given thickness using the heated doctor blade. The glass plate applied with the composite solution was stored in a leveled constant temperature/humidity chamber at 80° C. for about 2 hours to widely spread the solution. Then, the solution was controlled to a relative humidity of 40% to induce the hydrolysis of the polyphosphoric acid. Then, the temperature of the solution was reduced slowly to 40° C. over about 2˜3 days while the relative humidity thereof was increased to 80% and, at the same time, an excess of the phosphoric acid and water resulting from the hydrolysis of the polyphosphoric acid were removed according to circumstances. Finally, the formed composite electrolyte membrane was separated from the support.

Thereafter, the composite electrolyte membrane was thermally treated at 200° C. for 12 hours in an air atmosphere and normal pressure to crosslink and cure the aluminum-chromium-phosphate of the electrolyte membrane, thus preparing an organic/inorganic composite electrolyte membrane of polybenzimidazole/aluminum-chromium-phosphate (sample 1).

### Comparative Example 1

### Preparation of Polybenzimidazole Electrolyte Membrane (Sample 2)

An electrolyte membrane (sample 2) was prepared in the same manner as in Example 4, except that the polyphosphoric acid solution of polyparabenzimidazole prepared in Example 1 was used instead of the polybenzimidazole/aluminum-chromium-phosphate composite solution prepared in Example 3.

### Example 5

### Preparation of Aluminum-Chromium-Phosphate Complex-Containing Electrode

The aluminum-chromium-phosphate (MCP) complex solution prepared in Example 2, a catalyst (Pt/C), distilled water, a 60% polytetrafluoroethylene (PTFE) solution and IPA (isopropylalcohol) were mixed with each other at a weight ratio Pt/C:H₂O:PTFE:MCP:IPA=1:3:6:10:100, and stirred. Then, the mixture was applied on a gas diffusion layer (GDL) of carbon cloth and was crosslinked and cured at 300° C. for 3 hours, thus preparing an electrode.

### EXPERIMENTS

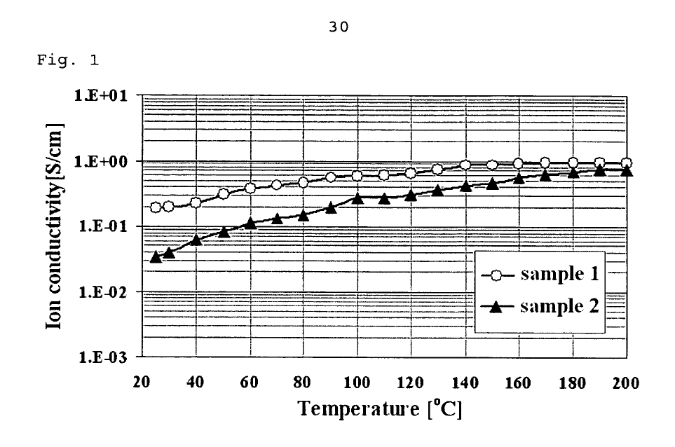

The properties of the composite electrolyte membrane sample prepared in each of Example 4 and Comparative Example 1 were measured in the following manner, and the measurement results are shown in Table 1 below and FIG. 1.

### Experiment 1

### Measurement of Phosphoric Acid Doping Level

The acid doping level of the electrolyte membrane was measured using a neutralization titration method. 1 g of the prepared electrolyte membrane was boiled in 300 ml of distilled water to extract doped phosphoric acid from the membrane, and the extracted phosphoric acid was titrated with a 0.1 N NaOH standard solution to calculate the moles of the phosphoric acid. The electrolyte membrane from which the phosphoric acid has been removed was dried in a vacuum oven at 120° C. for at least 24 hours, and then the weight thereof was measured. The number of doped phosphoric acids per imidazole unit of the polymer, the doping level, was calculated according to Equation 1 below, and the calculation results are shown in Table 1 below.

$$\begin{matrix}phosphoric acid \\ doping level\end{matrix} = \frac{moles of doped phosphoric acid}{\frac{weight of dried electrolyte membrane}{molecular weight per polymer repeat unit} \times \begin{matrix}imidazoles \\ per polymer repeat unit\end{matrix}} \qquad [ Equation 1 ]$$

wherein the moles of doped phosphoric acid are the moles of 0.1 N NaOH used in titration.

### Experiment 2

### Measurement of Mechanical Strength

The strength properties of each of the electrolyte membrane samples were measured using Zwick UTM. In conditions of room temperature and 25% humidity, each of the electrolyte membrane samples was prepared into a dog bone-shaped film satisfying the requirements of ASTM D-882 (Standard Test Method for Tensile Properties of Thin Plastic Sheeting). The tensile strength of the prepared film was measured five times at a crosshead speed of 50 mm/min, and the average value of the measured tensile strengths is shown in Table 1 below.

### Experiment 3

### Measurement of Hydrogen Ion Conductivity

The ion conductivity of each of the samples was measured with the ZAHNER IM-6 impedance analyzer using the potentio-static two-probe method in a frequency range of 1 Hz˜1 MHz at a temperature of 20˜200° C. in non-humidified conditions. The measurement results are shown in FIG. 1.

TABLE 1

| | Phosphoric | | Stress | |
|---|---|---|---|---|
| Electrolyte | acid doping | Apparent | at break | Strain |
| membranes | levels | properties | (MPa) | (%) |
| Sample 1 | 3.4 | Transparent; | 24.1 | 260 |
| (Example 4) | | excellent | | |
| | | mechanical | | |
| | | strength | | |
| Sample 2 | 4.6 | Transparent; | 26.7 | 180 |
| Comparative | | excellent | | |
| Example 1) | | mechanical | | |
| | | strength | | |

As can be seen in Table 1 above, Comparative Example 1 (sample 2) showed a phosphoric acid doping level higher than that of Example 4 (sample 1). As known in the art, the phosphoric acid doping level contributes to cation conductivity.

However, as shown in FIG. 1, the hydrogen ion conductivity of Example 4 (sample 1) was higher than that of Comparative Example 1, suggesting that the aluminum-chromium-phosphate contained in the electrolyte membrane contributed to the increase in hydrogen ion conductivity.

### INDUSTRIAL APPLICABILITY

As described above, the metal(III)-chromium-phosphate complex according to the present invention and the organic/inorganic composite electrolyte membrane and the electrode for fuel cells prepared using the complex show high hydrogen ion conductivity in a wide temperature range including high temperatures and non-humidified conditions, do not require a post-treatment process with strong acid, etc., have excellent chemical resistance and thermal stability, show a low decrease in the ion conductivity thereof with the passage of operating time, and show increased catalyst activity due to chromium contained therein.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A metal(III)-chromium-phosphate (MCP) complex represented by Formula (1):
M(III)ₓCr(HPO₄)_{y}(H₂PO₄)_{z} (1)
wherein M is a group IIIA and/or group IIIB metal, x is 3n (n=1 or 2), y is 3n′ (n′=0, 1 or 2), z is 3n″ (n″=0, 1 or 2), at least one of n′ and n″ is not zero.

2. The MCP complex of claim 1, wherein M in Formula (1) is Al.

3. The MCP complex of claim 1, which is prepared by allowing (i) metal hydroxide (M(OH)₃) and/or metal oxide (M₂O₃) and (ii) chromium oxide (CrO₃) to react with (iii) polyphosphoric acid (Hₙ₊₂PₙO₃ₙ₊₁; n=an integer of 1 or greater).

4. An organic/inorganic composite electrolyte membrane comprising: an organic polymer; and a metal(III)-chromium-phosphate (MCP) complex represented by Formula (1), dispersed on a matrix of said organic polymer:
M(III)ₓCr(HPO₄)_{y}(H₂PO₄)_{z} (1)
wherein M is a group IIIA and/or group IIIB metal, x is 3n (n=1 or 2), y is 3n′ (n′=0, 1 or 2), z is 3n″ (n″=0, 1 or 2), at least one of n′ and n″ is not zero.

5. The organic/inorganic composite electrolyte membrane of claim 4, wherein the organic polymer is at least one selected from the group consisting of PTFE (polytetrafluoroethylene), PVDF (polyvinylidenefluoride), Nafion polymers, PA (polyamide) polymers, PI (polyimide) polymers, PVA (polyvinylalcohol) polymers, PAE (polyaryleneether) polymers and polyazole polymers.

6. The organic/inorganic composite electrolyte membrane of claim 4, wherein the organic polymer has at least one hydrogen ion exchange group selected from the group consisting of a sulfonic acid group, a phosphoric acid group, a hydroxyl group, and a carboxylic acid group.

7. The organic/inorganic composite electrolyte membrane of claim 4, wherein the MCP complex is contained in an amount of 0.1˜1000 parts by weight based on 100 parts by weight of the organic polymer.

8. The organic/inorganic composite electrolyte membrane of claim 4, which is prepared through a method comprising the steps of:
(i) mixing said organic polymer or a solution thereof with said MCP complex or a solution thereof to prepare a mixture; and
(ii) forming said mixture into a membrane, and then crosslinking and/or curing the membrane.

9. An electrode for fuel cells, comprising a metal(III)-chromium-phosphate (MCP) complex represented by Formula (1):
M(III)ₓCr(HPO₄)_{y}(H₂PO₄)_{z} (1)
wherein M is a group IIIA and/or group IIIB metal, x is 3n (n=1 or 2), y is 3n′ (n′=0, 1 or 2), z is 3n″ (n″=0, 1 or 2), at least one of n′ and n″ is not zero.

10. The electrode of claim 9, which is prepared by applying the MCP complex solution, a noble metal-based catalyst, a binder and a solvent on a gas diffusion layer, followed by crosslinking and/or curing.

11. The electrode of claim 9, wherein the MCP complex is used in an amount of 0.1˜1000 parts by weight based on 100 parts by weight of the binder.

12. The electrode of claim 9, wherein the binder is an organic polymer having at least one hydrogen ion exchange group selected from the group consisting of a sulfonic acid group, a phosphoric acid group, a hydroxyl group and a carboxylic acid group.

13. A membrane-electrode assembly (MEA) for fuel cells, comprising a cathode, an anode and an electrolyte membrane placed between the cathode and the anode,
in which (i) the electrolyte membrane is the organic/inorganic composite electrolyte membrane comprising: an organic polymer; and a metal(III)-chromium-phosphate (MCP) complex represented by Formula (1), dispersed on a matrix of said organic polymer, and/or (ii) at least one of the cathode and the anode is the electrode comprising the metal(III)-chromium-phosphate (MCP) complex represented by Formula (1):
M(III)ₓCr(HPO₄)_{y}(H₂PO₄)_{z} (1)
wherein M is a group IIIA and/or group IIIB metal, x is 3n (n=1 or 2), y is 3n′ (n′=0, 1 or 2), z is 3n″ (n″=0, 1 or 2), at least one of n′ and n″ is not zero.

14. The membrane-electrode assembly (MEA) of claim 13, wherein the organic polymer is at least one selected from the group consisting of PTFE (polytetrafluoroethylene), PVDF (polyvinylidenefluoride), Nafion polymers, PA (polyamide) polymers, PI (polyimide) polymers, PVA (polyvinylalcohol) polymers, PAE (polyaryleneether) polymers and polyazole polymers.

15. The membrane-electrode assembly (MEA) of claim 13, wherein the organic polymer has at least one hydrogen ion exchange group selected from the group consisting of a sulfonic acid group, a phosphoric acid group, a hydroxyl group, and a carboxylic acid group.

16. The membrane-electrode assembly (MEA) of claim 13, which is prepared by bringing the cathode, the anode and the electrolyte membrane placed therebetween into close contact with each other, and crosslinking and/or curing the resulting structure at a temperature of 100˜400° C.

17. The membrane-electrode assembly (MEA) of claim 13, wherein the organic/inorganic composite electrolyte membrane is prepared through a method comprising the steps of:
(i) mixing said organic polymer or a solution thereof with said MCP complex or a solution thereof to prepare a mixture; and
(ii) forming said mixture into a membrane, and then crosslinking and/or curing the membrane.

18. The membrane-electrode assembly (MEA) of claim 13, wherein the electrode is prepared by applying the MCP complex solution, a noble metal-based catalyst, a binder and a solvent on a gas diffusion layer, followed by crosslinking and/or curing.

19. A fuel cell comprising a membrane-electrode assembly according to claim 13.

20. The fuel cell of claim 19, which uses non-humidified hydrogen as fuel.
